(19) United States
(12) Patent Application Publication
(10) Pub. No.: US 2016/0326290 A1
(43) Pub. Date: Nov. 10, 2016

(54) MOISTURE-CURABLE, SEMI-CRYSTALLINE (METH)ACRYLIC OLIGOMERS AND METHODS OF MAKING AND USING SAME IN ADHESIVE ARTICLES

(71) Applicant: 3M INNOVATIVE PROPERTIES COMPANY, St. Paul, MN (US)

(72) Inventors: Ramesh C. Kumar, Woodbury, MN (US); Mark F. Ellis, St. Paul, MN (US); John R. Jacobsen, Woodbury, MN (US); Michael A. Lockett, St. Paul, MN (US); Rajdeep S. Kalgutkar, Woodbury, MN (US)

(73) Assignee: 3M INNOVATIVE PROPERTIES COMPANY, St. Paul, MN (US)

(21) Appl. No.: 15/108,324

(22) PCT Filed: Dec. 22, 2014
(86) PCT No.: PCT/US14/71794

§ 371 Date: Jun. 27, 2016

Related U.S. Application Data
(60) Provisional application No. 61/921,241, filed on Dec. 27, 2013.

(51) Int. Cl. C08F 220/68; B05D 1/04; B05D 1/02; B05D 1/18; C09J 7/02; B05D 1/30

(52) U.S. Cl. CPC C08F 220/68; C09J 7/0285; B05D 1/305; B05D 1/02; B05D 1/18; B05D 1/04; C09J 2433/00; C09J 2467/006

(57) ABSTRACT

A composition suitable for use as a low adhesion backsize or a primer for low surface energy adhesives, including the reaction product of at least one moisture-curable, semi-crystalline (meth)acrylic oligomer represented by the formula: wherein R₁ is independently a C₁₆ to C₄₀ alkyl group; R₂ is independently a C₁ to C₄₀ alkyl group; each R₃ is independently a methyl, ethyl, or isopropyl group; X is a chain transfer agent as defined further below; Y is independently selected to be a methyl, ethyl, or isopropyl group; a, b and c are each independently selected to be an integer of at least 10, and a+b+c<1500; n>1; and p is 0, 1, 2, or 3. Articles and methods of using the composition as a low adhesion backsize or a primer for a low surface energy adhesive are also described.

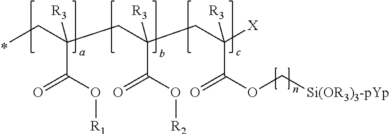

### FIELD

The present disclosure relates to moisture-curable, semi-crystalline (meth)acrylic oligomers, and more particularly to methods of using such oligomers in a low adhesion backsize, or a primer for adhesive articles.

### BACKGROUND

Normally tacky and pressure-sensitive adhesive tapes have been widely used for well over half a century. Products of this type, which typically feature a sheet backing coated on one side with an adhesive that adheres to a wide variety of surfaces upon the application of pressure alone, are often sold in roll form. To permit the roll to be unwound without the undesirable transfer of adhesive to the back side of the backing, it is customary to provide the backing surface with a low adhesion backsize (LAB) to which the adhesive bonds less firmly.

Polymeric release materials are known to be used in release layers in release articles (e.g., release liners) and adhesive articles (e.g., adhesive tapes) in order to provide a surface from which an adhesive can be easily and cleanly removed. For example, it is known to apply a polymeric release material to the back surface of an adhesive tape (e.g., a box sealing tape) in order to allow the tape to be provided in roll form and to be easily and conveniently dispensed by unwinding the roll.

### SUMMARY

Moisture-curing polymer systems, including moisture-curing siloxane polymers (i.e., silicones), are known. Siloxane polymers have unique properties derived mainly from the physical and chemical characteristics of the siloxane bond. These properties include low glass transition temperature, thermal and oxidative stability, resistance to ultraviolet radiation, low surface energy and hydrophobicity, high permeability to many gases, and biocompatibility. The siloxane polymers, however, often lack tensile strength.

The low tensile strength of the siloxane polymers can be improved by forming block copolymers. Some block copolymers contain a “soft” siloxane polymeric block or segment and any of a variety of “hard” blocks or segments. Polydiorganosiloxane polyamides, polydiorganosiloxane polyureas, and polydiorganosiloxane polyoxamide copolymers are exemplary block copolymers. However, many of the known siloxane-based polyamide block copolymers contain relatively short segments of the polydiorganosiloxane (e.g., polydimethylsiloxane) such as segments having no greater than 30 diorganosiloxy (e.g., dimethylsiloxy) units or the amount of the polydiorganosiloxane segment in the copolymer is relatively low. That is, the fraction (i.e., amount based on weight) of polydiorganosiloxane (e.g., polydimethylsiloxane) soft segments in the resulting copolymers tends to be low. Although these block copolymers have many desirable characteristics, some of them tend to degrade when subjected to elevated temperatures such as 250° C. or higher, or are otherwise not well-suited for applications requiring weathering durability or environmental exposure.

Briefly, in one aspect, the present disclosure describes a composition including at least one moisture-curable, semi-crystalline (meth)acrylic oligomer formed as a reaction product of an alkyl (meth)acrylate compound having a carbon number from 16 to 40, an alkyl (meth)acrylate compound having a carbon number from 1 to 40, and at least one alkoxysilane compound including a (meth)acryloyl-functionality or a mercapto-functionality, wherein the at least one alkoxy silane compound includes alkyl moieties containing from 1-3 carbon atoms.

More particularly, the present disclosure describes a composition including at least one moisture-curable, semi-crystalline (meth)acrylic oligomer represented by the formula:

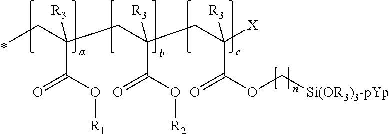

wherein:
R₁ is independently a C₁₆ to C₄₀ alkyl group;
R₂ is independently a C₁ to C₄₀ alkyl group;
each R₃ is independently a methyl, ethyl, or isopropyl group;
X is a chain transfer agent as defined further below;
Y is independently selected to be a methyl, ethyl, or isopropyl group;
a, b and c are each independently selected to be an integer of at least 10, and a+b+c<1500; n>1; and
p is 0, 1, 2, or 3.

In certain exemplary embodiments, (co)polymerizing the reaction mixture includes free radical polymerization under essentially adiabatic conditions. In any of the foregoing embodiments, the composition can be substantially free of organic solvents.

In another aspect, the present disclosure describes a process for making the composition including the at least one moisture-curable, semi-crystalline (meth)acrylic oligomer, the process including chemically reacting a reaction mixture containing an alkyl (meth)acrylate having a carbon number from 16 to 30, an alkyl (meth)acrylate having a carbon number from 1 to 15, and an alkoxysilane compound including a (meth)acryloyl-functionality or a mercapto-functionality, wherein the alkoxy silane compound includes alkyl moieties containing from 1-3 carbon atoms. In some exemplary embodiments, the alkoxy silane compound is selected from 3-mercaptopropyl trimethoxysilane, 3-methacryloxypropyl-trimethoxysilane, and combinations thereof. In certain exemplary embodiments, chemically reacting the reaction mixture includes free radical polymerization under essentially adiabatic conditions.

In yet another aspect, the present disclosure describes an article including a low adhesion backsize (LAB), or a primer for a low surface energy adhesive applied to a major surface of a substrate. The LAB or primer includes a moisture-curable, semi-crystalline (meth)acrylic oligomer of any of the foregoing compositions, and more particularly, a reaction product of a moisture-curable, semi-crystalline (meth)acrylic oligomer of any of the foregoing compositions, with hydroxyl groups present on a major surface of a substrate, as described further below.

In certain exemplary embodiments, the article is an adhesive article, and preferably a pressure-sensitive adhesive (PSA) article. In one such exemplary embodiment, the adhesive article is a liner-less adhesive tape, and the cured semi-crystalline (meth)acrylic oligomer acts as a low adhesion backsize (LAB). In other exemplary embodiments, the adhesive article includes a primer layer comprising the foregoing semi-crystalline (meth)acrylic oligomer cured by reaction with a plurality of hydroxyl groups present on the major surface of the substrate, and an adhesive layer applied over and adjacent to the primer layer on the major surface of the substrate. Advantageously, the adhesive is a low surface energy adhesive, such as an adhesive derived from a polysiloxane (i.e., a silicone adhesive).

The adhesive layer may include one or more adhesive selected from a pressure sensitive adhesive, a hot melt adhesive, a radiation curable adhesive, a tackified adhesive, a non-tackified adhesive, a synthetic rubber adhesive, a natural rubber adhesive, a (meth)acrylic (co)polymer adhesive, a silicone adhesive, and a polyolefin adhesive. In certain such exemplary adhesive article embodiments, the substrate is selected from a (co)polymeric film, paper, woven cloth, non-woven cloth, and a web comprised of non-woven (co)polymeric fibers. In some advantageous embodiments, the substrate is a (co)polymeric film. In certain particularly advantageous embodiments, the substrate is selected to have a plurality of hydroxyl groups on a major surface of the substrate with which the alkoxy silane may react, thereby chemically anchoring (i.e., covalently bonding) the semi-crystalline (meth)acrylic oligomer to the substrate surface.

In one additional aspect, the present disclosure describes a process for making any of the foregoing adhesive articles, including applying the moisture-curable, semi-crystalline (meth)acrylic oligomer composition to a major surface of a substrate, and curing the moisture-curable, semi-crystalline (meth)acrylic oligomer by reaction with a plurality of hydroxyl groups present on the major surface of the substrate.

### Listing of Exemplary Embodiments

A. A composition comprising at least one moisture-curable, semi-crystalline (meth)acrylic oligomer formed as a reaction product of an alkyl (meth)acrylate compound having a carbon number from 16 to 40, an alkyl (meth)acrylate compound having a carbon number from 1 to 40, and at least one alkoxysilane compound including a (meth)acryloyl-functionality or a mercapto-functionality, wherein the at least one alkoxy silane compound includes alkyl moieties containing from 1-3 carbon atoms.
B. The composition of embodiment A, wherein the at least one moisture curable, semi-crystalline
(meth)acrylic oligomer is represented by the formula:

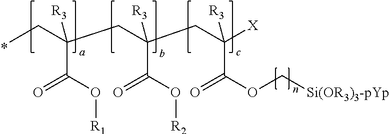

wherein:
R₁ is independently a C₁₆ to C₄₀ alkyl group;
R₂ is independently a C₁ to C₄₀ alkyl group;
each R₃ is independently a methyl, ethyl, or isopropyl group;
X is a chain transfer agent;
Y is independently selected to be a methyl, ethyl, or isopropyl group;
a, b and c are each independently selected to be an integer of at least 10, and a+b+c<1500;
n>1; and
p is 0, 1, 2, or 3.
C. The composition of embodiment B, wherein R₁ comprises an alkyl (meth)acrylate having a carbon number from 16 to 30.
D. The composition of embodiment B, or C, wherein R₁ comprises an alkyl (meth)acrylate having a carbon number from 18 to 30.
E. The composition of any one of embodiments B, C, or D, wherein R₂ comprises a least one monomer selected from the group consisting of an alkyl (meth)acrylate having a carbon number from 1 to 15, an alkyl (meth)acrylate having a carbon number from 16 to 40, a poly(ethylene) glycol-functional alkyl (meth)acrylate, a poly(propylene) glycol-functional alkyl (meth)acrylate, a urethane-functional alkyl (meth)acrylate, an epoxy-functional alkyl (meth)acrylate, or a combination thereof.
F. The composition of embodiment E, wherein R₂ comprises an alkyl (meth)acrylate having a carbon number from 1 to 8.
G. The composition of embodiment F, wherein the amount of R₂ in the moisture-curable, semi-crystalline (meth)acrylic oligomer is less than 30% w/w based on the total weight of the moisture-curable, semi-crystalline (meth)acrylic oligomer.
H. The composition of any one of embodiments B, C, D, E, F, or G, wherein at least one R₃ is selected to be different from another R₃.
I. The composition of any one of embodiments B, C, D, E, F, G, or H, wherein each R₃ is selected to be methyl.
J. The composition of any one of embodiments B, C, D, E, F, G, H or I, wherein n is no greater than 1500.
K. The composition of any one of embodiments B, C, D, E, F, G, H, I, or J, wherein the at least one moisture curable, semi-crystalline (meth)acrylic oligomer has a weight average molecular weight less than or equal to 10,000 Da.
L. The composition of any preceding embodiment, wherein the composition is substantially free of organic solvents.
M. An adhesive article comprising the composition of any preceding embodiment, optionally wherein the composition is at least partially cured to produce a low adhesion backsize opposite an adhesive layer on a substrate, or a primer layer for a low surface energy adhesive applied to the primer layer on a substrate.
N. The adhesive article of embodiment M, wherein the substrate is selected from glass, ceramics, metals, metal oxides, cellulose, cellulose acetate, ethyl cellulose, poly(ethylene terephthalate), poly(ethylene naphthalate), polycarbonate, polypropylene, biaxially-oriented polypropylene, polyethylene, polybutylene, polyamides, or a combination thereof.
O. A process for making the composition of any one of claims B, C, D, E, F, G, H, I, or J, or K, comprising:

reacting a reaction mixture comprising:
an alkyl (meth)acrylate having a carbon number from 16 to 30;
an alkyl (meth)acrylate having a carbon number from 1 to 40; and
an alkoxysilane compound including a (meth)acryloyl-functionality or a mercapto-functionality, wherein the alkoxy silane compound comprises alkyl moieties containing from 1-3 carbon atoms.
   P. The process of embodiment O, wherein the alkoxy silane compound is selected from 3-mercaptopropyl trimethoxysilane, 3-methacryloxypropyltrimethoxysilane, and combinations thereof.
   Q. The process of any one of embodiment O or P, wherein reacting the reaction mixture comprises free radical polymerization, optionally under essentially adiabatic conditions, optionally in the absence of an organic solvent.
   R. A process for making the adhesive article of any one of embodiment M or N, comprising applying the moisture-curable, semi-crystalline (meth)acrylic oligomer composition to a major surface of a substrate, and optionally curing the moisture-curable, semi-crystalline (meth)acrylic oligomer by reaction with a plurality of hydroxyl groups present on the major surface of the substrate.
   S. The process of embodiment R, wherein applying the moisture-curable, semi-crystalline (meth)acrylic oligomer composition to the major surface of the substrate comprises roll coating, Mayer rod coating, knife coating, curtain coating, slide coating, spray coating, electrospray coating, dip coating, gravure coating, bar coating, vapor coating, or a combination thereof.
   T. The process of embodiment R or S, further comprising heating the oligomer composition to accelerate reaction of the moisture-curable, semi-crystalline (meth)acrylic oligomer composition with a plurality of hydroxyl groups present on the major surface of the substrate.

Various aspects and advantages of exemplary embodiments of the present disclosure have been summarized. The above Summary is not intended to describe each illustrated embodiment or every implementation of the present disclosure. The Detailed Description that follows more particularly exemplifies certain presently preferred embodiments using the principles disclosed herein.

### DETAILED DESCRIPTION

The present disclosure provides moisture-curable, semi-crystalline (meth)acrylic oligomers. The oligomers may be prepared at 100% solids without added diluents or organic solvents. Due to their low viscosity, the oligomers may be applied to a variety of substrates using a variety of application methods. The oligomers may be reacted through a silane moiety with hydroxyl groups on a substrate surface, thereby covalently bonding or anchoring the cured oligomers as hydrophobic coatings for substrates, and are particularly useful as low adhesion backsizes (LABs) in adhesive articles, and as primers for low surface energy adhesives (e.g., silicone adhesives).

Throughout the specification, the recitation of numerical ranges by endpoints includes all numbers subsumed within that range (e.g., 1 to 5 includes 1, 1.5, 2, 2.75, 3, 3.8, 4, and 5). Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

For the following Glossary of defined terms, these definitions shall be applied for the entire application, unless a different definition is provided in the claims or elsewhere in the specification.

### GLOSSARY

Certain terms are used throughout the description and the claims that, while for the most part are well known, may require some explanation. It should be understood that, as used herein:

The terms “about” or “approximately” with reference to a numerical value or a shape means+/−five percent of the numerical value or property or characteristic, but expressly includes the exact numerical value. For example, a temperature of “about” 100° C. refers to a temperature from 95° C. to 105° C., but also expressly includes a temperature of exactly 100° C.

The term “substantially” with reference to a property or characteristic means that the property or characteristic is exhibited to a greater extent than the opposite of that property or characteristic is exhibited. For example, a process that is “substantially” adiabatic refers to a process in which the amount of heat transferred out of a process is the same as the amount of heat transferred into the process, with +/−5%.

The terms “a”, “an”, and “the” include plural referents unless the content clearly dictates otherwise. Thus, for example, reference to a material containing “a compound” includes a mixture of two or more compounds.

The term “or” is generally employed in its sense including “and/or” unless the content clearly dictates otherwise.

The term “homogeneous” means exhibiting only a single phase of matter when observed at a macroscopic scale.

The term “non-heterogeneous” means “substantially homogeneous”.

The terms “copolymer(s)” and “copolymeric material” refer to a polymeric material having a weight average molecular weight of at least 10,000 Da and prepared from at least two monomers. The term “copolymer” includes random, block and star (e.g., dendritic) copolymers.

The terms “(co)polymer(s)” and “(co)polymeric material” refer to both polymeric materials prepared from one monomer such as a homopolymer, or to materials prepared from two or more monomers such as a copolymer, terpolymer, or the like. Thus, the terms “(co)polymer(s)” or “(co)polymeric material” encompass homopolymers and copolymers, as well as homopolymers or copolymers in a miscible blend, formed e.g., by co-extrusion or by reaction, including, e.g., transesterification.

Likewise, the term “(co)polymerize” refers to the process of making a polymeric material that can be a homopolymer, copolymer, terpolymer, or the like.

The terms “acrylic”, “(meth)acrylic” or “(meth)acrylate” with respect to a monomer, oligomer, or substituent group means a vinyl-functional alkyl ester formed as the reaction product of an alcohol with an acrylic or a methacrylic acid.

The term “alkenyl” refers to a monovalent group that is a radical of an alkene, which is a hydrocarbon with at least one carbon-carbon double bond. The alkenyl can be linear, branched, cyclic, or combinations thereof and typically contains 2 to 40 carbon atoms. In some embodiments, the alkenyl contains 2 to 30, 2 to 20, 2 to 18, 2 to 16, 2 to 12, 16 to 40, 16 to 30, 16 to 20, 18 to 40, 18 to 30, 18 to 20, 20 to 40, or 20 to 30 carbon atoms. Exemplary alkenyl groups include ethenyl, n-propenyl, and n-butenyl.

The term “alkyl” refers to a monovalent group that is a radical of an alkane, which is a saturated hydrocarbon. The alkyl can be linear, branched, cyclic, or combinations thereof and typically has 1 to 30 carbon atoms. In some embodiments, the alkyl group contains 1 to 40, 1 to 30, 1 to 20, 1 to 18, 1 to 16, 1 to 12, 16 to 40, 16 to 30, 16 to 20, 18 to 40, 18 to 30, 18 to 20, 20 to 40, or 20 to 30 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene often has 1 to 30 carbon atoms. In some embodiments, the alkylene contains 1 to 40, 1 to 30, 1 to 20, 1 to 18, 1 to 16, 1 to 12, 16 to 40, 16 to 30, 16 to 20, 18 to 40, 18 to 30, 18 to 20, 20 to 40, or 20 to 30 carbon atoms. The radical centers of the alkylene can be on the same carbon atom (i.e., an alkylidene) or on different carbon atoms.

The term “alkoxy” refers to a monovalent group of formula —OR where R is an alkyl group.

The term “halo” refers to fluoro, chloro, bromo, or iodo.

The term “haloalkyl” refers to an alkyl having at least one hydrogen atom replaced with a halo. Some haloalkyl groups are fluoroalkyl groups, chloroalkyl groups, or bromoalkyl groups.

The term “polydiorganosiloxane” refers to a divalent segment of formula

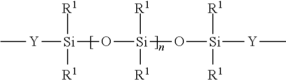

where each R¹ is independently an alkyl, haloalkyl, aralkyl, alkenyl, aryl, or aryl substituted with an alkyl, alkoxy, or halo; each Y is independently an alkylene, aralkylene, or a combination thereof; and subscript n is independently an integer of 0 to 1500.

The term “cross-linked” (co)polymer refers to a (co)polymer whose molecular chains are joined together by covalent chemical bonds, usually via cross-linking molecules or groups, to form a network (co)polymer. A cross-linked (co)polymer is generally characterized by insolubility, but may be swellable in the presence of an appropriate solvent.

The terms “room temperature” and “ambient temperature” are used interchangeably to mean temperatures in the range of 20° C. to 25° C.

The term “glass transition temperature” or “T_{g}” refers to the glass transition temperature of a (co)polymer when evaluated in bulk rather than in a thin film form. In instances where a (co)polymer can only be examined in thin film form, the bulk form T_{g} can usually be estimated with reasonable accuracy. Bulk form T_{g} values usually are determined by evaluating the rate of heat flow vs. temperature using differential scanning calorimetry (DSC) to determine the onset of segmental mobility for the (co)polymer and the inflection point (usually a second-order transition) at which the (co)polymer can be said to change from a glassy to a rubbery state. Bulk form T_{g} values can also be estimated using a dynamic mechanical thermal analysis (DMTA) technique, which measures the change in the modulus of the (co)polymer as a function of temperature and frequency of vibration.

As defined herein, by “essentially adiabatic” it is meant that total of the absolute value of any energy exchanged to or from the reaction mixture during the course of reaction will be less than about 15% of the total energy liberated due to reaction for the corresponding amount of (co)polymerization that has occurred during the time that (co)polymerization has occurred. Expressed mathematically, the essentially adiabatic criterion (for monomer polymerization) is:

$${\int }_{{t}_{1}}^{{t}_{2}} {\sum }_{j = 1}^{N} \vert {q}_{j} ( t ) \vert d t \leq f \cdot {\int }_{{x}_{1}}^{{x}_{2}} Δ {H}_{p} ( x ) d x$$

where f is about 0.15, ΔHₚ is the heat of (co)polymerization, x=monomer conversion=(M_{O}−M)/M_{O} where M is the concentration of the monomer and M_{O} is the initial monomer concentration, x₁ is the (co)polymer fraction at the start of the reaction and x₂ is the (co)polymer fraction due to (co)polymerization at the end of the reaction, t is the time. t₁ is the time at the start of reaction, t₂ is the time at the end of reaction, and qⱼ(t), wherein j=1 . . . N is the rate of energy transferred to the reacting system from the surroundings from all N sources of energy flow into the system.

Examples of energy transfer sources for qⱼ(t), wherein j=1 . . . N include, but are not limited to, heat energy conducted to or from the reaction mixture from the reactor jacket, energy required to warm internal components in the reaction equipment such as the agitator blades and shaft, and work energy introduced from mixing the reacting mixture. In the practice of the present disclosure, having f as close to zero as possible is preferred to maintain uniform conditions within a reaction mixture during a reaction (that is, maintain homogeneous temperature conditions throughout a reaction mixture) which helps to minimize batch-to-batch variations in a particular piece of equipment as well as minimize batch-to-batch variations when reactions are made in batch reactors of differing sizes (that is, uniform scale up or scale down of reaction).

The term “layer” means a single stratum formed between two major surfaces. A layer may exist internally within a single article, e.g., a single stratum formed with multiple strata in a single article having first and second major surfaces defining the thickness of the article. A layer may also exist in a composite article comprising multiple layers, e.g., a single stratum in a first article having first and second major surfaces defining the thickness of the article, when that article is overlaid or underlaid by a second article having first and second major surfaces defining the thickness of the second article, in which case each of the first and second articles forms at least one layer. In addition, layers may simultaneously exist within a single article and between that article and one or more other articles, each article forming a layer.

The term “adjoining” with reference to a particular first layer means joined with or attached to another, second layer, in a position wherein the first and second layers are either next to (i.e., adjacent to) and directly contacting each other, or contiguous with each other but not in direct contact (i.e., there are one or more additional layers intervening between the first and second layers).

By using terms of orientation such as “atop”, “on”, “covering”, “uppermost”, “underlying” and the like for the location of various elements in the disclosed coated articles, we refer to the relative position of an element with respect to a horizontally-disposed, upwardly-facing substrate. It is not intended that the substrate or articles should have any particular orientation in space during or after manufacture.

By using the term “overcoated” to describe the position of a layer with respect to a substrate or other element of a film of this present disclosure, we refer to the layer as being atop the substrate or other element, but not necessarily contiguous to either the substrate or the other element.

By using the term “separated by” to describe the position of a (co)polymer layer with respect to two inorganic barrier layers, we refer to the (co)polymer layer as being between the inorganic barrier layers but not necessarily contiguous to either inorganic barrier layer.

Various exemplary embodiments of the present disclosure will now be described. Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof.

### Materials

The present disclosure provides a composition comprising at least one moisture-curable, semi-crystalline (meth)acrylic oligomer formed as a reaction product of an alkyl (meth)acrylate having a carbon number from 16 to 40, an alkyl (meth)acrylate having a carbon number from 1 to 40, and at least one alkoxysilane compound including a (meth)acryloyl-functionality or a mercapto-functionality, wherein the at least one alkoxy silane compound includes alkyl moieties containing from 1-3 carbon atoms.

Moisture-Curable, Semi-Crystalline (Meth)Acrylic Oligomers

More particularly, the present disclosure provides a composition comprising at least one moisture-curable, semi-crystalline (meth)acrylic oligomer according to the general formula:

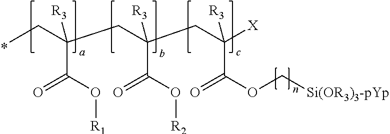

wherein:
R₁ is independently a C₁₆ to C₄₀ alkyl group;
R₂ is independently a C₁ to C₄₀ alkyl group;
each R₃ is independently a methyl, ethyl, or isopropyl group;
X is a chain transfer agent as defined further below;
Y is independently selected to be a methyl, ethyl, or isopropyl group;
a, b and c are each independently selected to be an integer of at least 10, and a+b+c<1500;
n>1; and
p is 0, 1, 2, or 3.

The value of n reflects the molecular weight of the siloxane portion of the moisture-curable semi-crystalline (meth)acrylic oligomer. The subscript n is an integer of 1 or greater. Typically, the value of n may be no greater than 1500. A wide range of n values are possible and available. For example, subscript n can be an integer up to 1000, up to 500, up to 400, up to 300, up to 200, up to 100, up to 80, up to 60, up to 50, up to 40, up to 20, or up to 10. The value of n is often at least 1, at least 2, at least 3, at least 5, at least 10, at least 20, or at least 40. For example, subscript n can be in the range of 40 to 1500, 0 to 1000, 40 to 1000, 0 to 500, 1 to 500, 40 to 500, 1 to 400, 1 to 300, 1 to 200, 1 to 100, 1 to 80, 1 to 40, or 1 to 20. It is presently preferred that n is between 1 and 20, more preferably between 1 and 18, or even more preferably between 1 and 16.

The molecular weight of the siloxane portion of the semi-crystalline (meth)acrylic oligomer(s) greatly affects the final properties of the (co)polymers prepared from the moisture-curable oligomer(s). Thus, in any of the foregoing embodiments, n may be no greater than 1500, 1,000, 500, 100, or 50. More preferably, n is no greater than 20, even more preferably no greater than 18.

Advantageously, the molecular weight (i.e., weight average molecular weight, M_{w}) of the moisture-curable semi-crystalline (meth)acrylic oligomer(s) is <10,000 Da, <9,000 Da, <8,000 Da, <7,000 Da, <6,000 Da, <5,000 Da, <4,000 Da, <3,000 Da; <2,000 Da; <1,000 Da; or even <500 Da.

The molecular weight growth may preferably be limited by the use of reactive chain transfer agents such as, for example, 3-mercaptopropyl trimethoxysilane. This results in lower M_{w} oligomers that terminate with trialkoxysilane (e.g., trimethoxysilane) functionality, and are thus reactive with water and surfaces comprising hydroxy groups, such as most inorganic metal oxide surfaces.

The use of lower M_{w} semi-crystalline (meth)acrylic oligomers is an advantage during delivery and coating of the oligomers due to the intrinsically lower viscosity of such oligomers when compared with higher M_{w} polymers. However, the weathering performance of these oligomers when used as surface coating is not compromised, since the (co)polymeric reaction product of the oligomer(s) with surface hydroxyl groups on a major surface of a substrate chemically anchors the reaction product of the oligomer(s) to the substrate surface, resulting in improved adhesion of the surface coating to the substrate.

In exemplary embodiments of any of the foregoing oligomers, R₁ is a substituent derived from an alkyl (meth)acrylate monomer, wherein R₁ has a carbon number from 16 to 40. In certain such exemplary embodiments, R₁ is a substituent derived from an alkyl (meth)acrylate monomer wherein R₁ has a carbon number from 18 to 30. In such exemplary embodiments, the amount of R₂ in the moisture-curable, semi-crystalline (meth)acrylic oligomer is advantageously selected to be from 1% w/w to 95% w/w, from 10% w/w to 90% w/w, from 25% w/w to 75% w/w, or even from 40% to 60% w/w, based on the total weight of the moisture-curable, semi-crystalline (meth)acrylic oligomer.

In exemplary embodiments of any of the foregoing oligomers, R₂ is a substituent derived from an alkyl (meth)acrylate monomer, wherein R₂ has a carbon number from 1 to 40. In some exemplary embodiments, R₂ advantageously has a carbon number from 1 to 15, more advantageously from 1 to 8. In such exemplary embodiments, the amount of R₂ in the moisture-curable, semi-crystalline (meth)acrylic oligomer is advantageously selected to be less than 30% w/w, less than 20% w/w, less than 10% w/w, or even less than 5% w/w, based on the total weight of the moisture-curable, semi-crystalline (meth)acrylic oligomer.

In other exemplary embodiments, R₂ advantageously has a carbon number from 16 to 40, more advantageously from 18 to 30. In such exemplary embodiments, the amount of R₂ in the moisture-curable, semi-crystalline (meth)acrylic oligomer is advantageously selected to be from 1% w/w to 95% w/w, from 10% w/w to 90% w/w, from 15% w/w to 85% w/w, or even from 20% w/w to 80% w/w based on the total weight of the moisture-curable, semi-crystalline (meth)acrylic oligomer.

In additional exemplary embodiments, R₂ comprises a least one monomer selected from the group consisting of an alkyl (meth)acrylate having a carbon number from 1 to 15, an alkyl (meth)acrylate having a carbon number from 16 to 40, a poly(ethylene) glycol-functional alkyl (meth)acrylate, a poly(propylene) glycol-functional alkyl (meth)acrylate, a urethane-functional alkyl (meth)acrylate, an epoxy-functional alkyl (meth)acrylate, or a combination thereof.

In certain exemplary embodiments, R₁ and R₂ may advantageously be derived from an alkyl (meth)acrylate monomer having the same carbon number. In other exemplary embodiments, R₁ and R₂ may advantageously be derived from alkyl (meth)acrylate monomers having different carbon numbers.

In further exemplary embodiments, at least one R₃ is advantageously selected to be selected to be different from another R₃. In some exemplary embodiments, at least one R₃ is advantageously selected to be selected to be the same as another R₃. In certain exemplary embodiments, each R₃ is selected to be the same as or alternatively, different from each other R₃. In some exemplary embodiments, each R₃ is selected to be methyl.

Additionally, the use of (meth)acrylic compounds (e.g., monomers) as the starting material for the oligomers allows the use of many different low cost commercially available monomers, thereby increasing the versatility and cost effectiveness of the oligomers as coatings for a variety of applications. Furthermore, (meth)acrylic compounds are readily available over a wide range of carbon numbers, allowing for flexible custom tailoring of the properties of the moisture curable semi-crystalline (meth)acrylic oligomers.

Crystalline (Meth)Acrylate Compound(s) [Monomer(s) and Oligomer(s)]

The moisture curable semi-crystalline (meth)acrylic oligomers include a crystalline (meth)acrylate side chain R₁ comprising one or more (co)polymerized crystalline (meth)acrylate compounds. Suitable crystalline (meth)acrylate compounds include, for example, monomers, oligomers or pre-polymers with melting transitions above room temperature (22° C.). In general, the crystalline (meth)acrylate monomers used in the reaction mixture that is (co)polymerized to form the oligomer(s) include esters of a long chain alkyl terminated primary alcohol, wherein the terminal alkyl chain is from at least 12 to about 40 carbon atoms in length, and a (meth)acrylic acid, preferably acrylic acid or methacrylic acid. The crystalline (meth)acrylate monomer is generally selected to be a C₁₂-C₄₀ alkyl ester of (meth)acrylic acid.

In some embodiments, the alkyl group contains 12 to 40, 12 to 30, 12 to 20, 12 to 18, 12 to 16, 16 to 40, 16 to 30, 16 to 20, 18 to 40, 18 to 30, 18 to 20, 20 to 40, or even 20 to 30 carbon atoms.

Suitable crystalline (meth)acrylate monomers include, for example, alkyl acrylates wherein the alkyl chain contains more than 11 carbon atoms (e.g., lauryl acrylate, tridecyl acrylate, tetradecyl acrylate, pentadecyl acrylate, hexadecyl acrylate, heptadecyl acrylate, octadecyl acrylate, nonadecyl acrylate, eicosanyl acrylate, behenyl acrylate, and the like); and alkylmethacrylates wherein the alkyl chain contains more than 11 carbon atoms (e.g., lauryl methacrylate, tridecyl methacrylate, tetradecyl methacrylate, pentadecyl methacrylate, hexadecyl methacrylate, heptadecyl methacrylate, octadecyl methacrylate, nonadecyl methacrylate, eicosanyl methacrylate, behenyl methacrylate, and the like). Presently preferred crystalline (meth)acrylate monomers include octadecyl acrylate, octadecyl methacrylate, behenyl acrylate, and behenyl methacrylate.

Vinyl-Functional (Meth)Acrylic Compound(s)

A variety of free radically (co)polymerizable co-monomers can be used in forming the side chain R₂ of the semi-crystalline (meth)acrylic oligomer(s) according to the present disclosure. Thus, in some exemplary embodiments, the free radically (co)polymerizable ethylenically-unsaturated material in the reaction mixture used to form the oligomer(s) is comprised of vinyl-functional monomers, more preferably, vinyl-functional (meth)acrylate monomers.

The identity and relative amounts of such components are well known to those skilled in the art. Particularly preferred among (meth)acrylate monomers are alkyl (meth)acrylates, preferably a monofunctional unsaturated acrylate ester of a non-tertiary alkyl alcohol, wherein the alkyl group contains 1 to about 17 carbon atoms, more preferably 1 to 12 carbon atoms, even more preferably 1 to 10 carbon atoms. Included within this class of monomers are, for example, isooctyl acrylate, isononyl acrylate, 2-ethylhexyl acrylate, decyl acrylate, dodecyl acrylate, n-butyl acrylate, hexyl acrylate, octadecyl acrylate, 2-methyl butyl acrylate, and mixtures thereof.

In some exemplary embodiments, the monofunctional unsaturated (meth)acrylate esters of a non-tertiary alkyl alcohol are selected from the group consisting of isooctyl acrylate, isononyl acrylate, 2-ethylhexyl acrylate, 2-octyl acrylate, 3-octyl acrylate, 4-octyl acrylate, decyl acrylate, dodecyl acrylate, n-butyl acrylate, hexyl acrylate, methyl acrylate, ethyl acrylate, butyl acrylate, methyl methacrylate, N-butyl methacrylate, 2-methyl butyl acrylate, and mixtures thereof.

In certain exemplary embodiments, the free radically (co)polymerizable ethylenically-unsaturated monomers are comprised of difficult to (co)polymerize monomers selected from N-vinyl pyrrolidone, N,N-dimethyl acrylamide, (meth)acrylic acid, acrylamide, N-octyl acrylamide, styrene, vinyl acetate, and combinations thereof.

Optionally, polar (co)polymerizable monomers can be (co)polymerized with the (meth)acrylate monomers to improve adhesion of the final adhesive composition to metals and also improve cohesion in the final adhesive composition. Strongly polar and moderately polar (co)polymerizable monomers can be used.

Strongly polar (co)polymerizable monomers include but are not limited to these selected from the group consisting of (meth)acrylic acid, itaconic acid, hydroxyalkyl acrylates, cyanoalkyl acrylates, acrylamides, substituted acrylamides, and mixtures thereof. A strongly polar (co)polymerizable monomer preferably constitutes a minor amount, for example, up to about 25 weight % of the monomer, more preferably up to about 15 weight %, of the monomer mixture. When strongly polar (co)polymerizable monomers are present, the alkyl acrylate monomer generally constitutes a major amount of the monomers in the acrylate-containing mixture, for example, at least about 75% by weight of the monomers.

Moderately polar (co)polymerizable monomers include, but are not limited to, those selected from the group consisting of N-vinyl pyrrolidone, N,N-dimethyl acrylamide, acrylonitrile, vinyl chloride, diallyl phthalate, and mixtures thereof. A moderately polar (co)polymerizable monomer preferably constitutes a minor amount, for example, up to about 40 weight %, more preferably from about 5 weight % to about 40 weight %, of the monomer mixture. When moderately polar (co)polymerizable monomers are present, the alkyl acrylate monomer generally constitutes at least about 60 weight % of the monomer mixture.

Alkoxy Silane(s)

The semi-crystalline (meth)acrylic oligomer(s) includes an alkoxy silane moiety formed by reacting an alkoxy silane compound with the reaction intermediate formed by (co)polymerizing the crystalline (meth)acrylate compound(s) with the (meth)acrylic co-monomer(s). In some exemplary embodiments, the alkoxy silane compound is selected from 3-mercaptopropyl trimethoxysilane, 3-methacryloxypropyl-trimethoxysilane, and combinations thereof.

Although the semi-crystalline (meth)acrylic oligomers are represented above as being comprised of a tri-alkoxy silane moiety, in some exemplary embodiments, the (meth)acrylic oligomers may be comprised of di-alkoxy or mono-alkoxy moieties. In such exemplary embodiments, one or two of the OR₃ moieties may be replaced by an alkyl or aryl group.

Generally there are two classes of moisture-curable alkoxy silane groups that are commercially, and therefore readily, available. In one class, two of the OR₃ groups are alkoxy groups and the other OR₃ group is replaced by an alkyl or aryl group. In the other readily available class, the OR₃ groups are the same and therefore all are alkoxy groups.

Examples of suitable moisture-curable alkoxy silane groups —SiR⁴R⁵R⁶ include, —Si(OMe)₃, —Si(OEt)₃, —Si(OPr)₃, —Si(OMe)₂Me, —Si(OEt)₂Me, —Si(OMe)₂Et, —Si(OEt)₂Et, —Si(OPr)₂Me, and the like, where Me=methyl, Et=ethyl and Pr=propyl (preferably isopropyl).

One presently-preferred tri-alkoxy silane is 3-mercaptopropyl trimethoxysilane, commercially available as A-189 from Alfa Aesar, Inc. (Ward Hill, Mass.). Another useful tri-alkoxy silane is 3-Methacryloxypropyltrimethoxysilane, commercially available as A-174 from Alfa Aesar, Inc. (Ward Hill, Mass.).

Alkoxy silanes are known to be useful as moisture-curing cross-linkers, adhesion promoters and filler coupling agents. Alkoxy silanes are subject to reaction with water to form silanol groups as shown in Reaction Scheme A. These silanol groups further condense to form —Si—O—Si— bonds. As can be seen from the reactions of Reaction Scheme A (wherein R′ and R^{c} represent alkyl, aralkyl or aryl groups) the overall transformation is catalytic in water (as much water is produced as is consumed) and generates an equivalent of an alcohol.

X—SiR′₂OR^{c}+H₂O→X—SiR′₂OH+HOR^{c}

2X—SiR′₂OH→X—SiR′₂—O—SiR′₂—X+H₂O Reaction Scheme A

The organofunctional group (X) reacts with organic groups or polymers. The silane end contains alkoxy groups (OR) that are activated (hydrolyzed) by reaction with ambient moisture to form silanol groups:

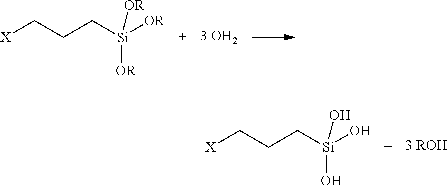

The silanol groups will condense with other silanols to form covalent bonds:

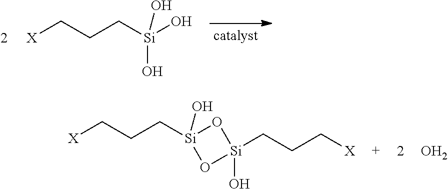

The silanol groups will also condense with reactive groups such as SiOH, AlOH or other metal oxides and hydroxides on the surfaces of fillers or substrates. Silanol groups generally form excellent bonds with the surfaces of silica, quartz, glass, aluminum and copper and form good bonds with the surfaces of mica, talc, inorganic oxides and (oxidized) steel or iron.

Chain Transfer Agents

Chain transfer agents, which are well known in the polymerization art, may also be included to control the molecular weight or other polymer properties. The term “chain transfer agent” as used herein also includes “telogens”. Suitable chain transfer agents for use in the inventive process include but are not limited to those selected from the group consisting of carbon tetrabromide, hexanebromoethane, bromotrichloromethane, 2-mercaptoethanol, t-dodecylmercaptan, isooctylthioglycoate, 3-mercapto-1,2-propanediol, cumene, and mixtures thereof. Depending on the reactivity of a particular chain transfer agent and the amount of chain transfer desired, typically 0 to about 5 percent by weight of chain transfer agent is used, preferably 0 to about 0.5 weight percent, based upon the total weight of monomer(s).

Free Radical Initiators

In some presently preferred embodiments, the oligomer is formed by co-polymerizing the crystalline (meth)acrylate compound(s) corresponding to R₁ and the (meth)acrylate compound(s) corresponding to R₂ in the presence of a free radical initiator. Useful initiators in the polymerization methods of the present disclosure are well known to practitioners skilled in the art and are detailed in Chapters 20 & 21 Macromolecules, Vol. 2, 2nd Ed., H. G. Elias, Plenum Press, 1984, New York.

Many possible thermal free radical initiators are known in the art of vinyl monomer polymerization and may be used in this disclosure. Typical thermal free radical polymerization initiators which are useful herein include, but are not limited to, organic peroxides, organic hydroperoxides, azo-group initiators which produce free radicals, peracids, and peresters.

Useful organic peroxides include but are not limited to compounds such as benzoyl peroxide, cumyl peroxide, tert-butyl peroxide, cyclohexanone peroxide, glutaric acid peroxide, lauroyl peroxide, methyl ethyl ketone peroxide, hydrogen peroxide, di-t-amyl peroxide, t-butyl-peroxy benzoate, 2,5-dimethyl-2,5 Di-(t-butylperoxy)hexane, 2,5-dimethyl-2,5-Di-(t-butyl-peroxy)hexyne-3, and di-cumyl peroxide.

Useful organic hydroperoxides include but are not limited to compounds such as t-amyl hydroperoxide, t-butyl hydroperoxide, and cumene hydroperoxide.

Useful azo compounds include but are not limited to 2,2-azo-bis-(isobutyronitrile), dimethyl 2,2′-azo-bis-(isobutyrate), azo-bis-(diphenyl methane), 4-4′-azo-bis-(4-cyano-pentanoic acid), 2,2′-azobis(2,4-dimethylpentanenitrile), 2,2′-azobis(2-methyl-propanenitrile), 2,2′-azobis(2-methylbutanenitrile), and 2,2′-azobis-(cyclohexanecarbonitrile).

Useful peracids include but are not limited to peracetic acid, perbenzoic acid, and potassium persulfate.

Useful peresters include but are not limited to diisopropyl percarbonate.

Certain of these initiators (in particular the peroxides, hydroperoxides, peracids, and peresters) can be induced to decompose by addition of a suitable catalyst rather than thermally. This redox method of initiation is described in Elias, Chapter 20.

Preferably, the initiator used comprises a thermally decomposed azo or peroxide compound for reasons of solubility and control of the reaction rate. Most preferably, the initiator used comprises an azo initiator for reasons of cost and appropriate decomposition temperature. Useful azo compound initiators include but are not limited to the VAZO compounds manufactured by DuPont, such as VAZO 52 (2,2′-azobis(2,4-dimethylpentanenitrile)), VAZO 64 (2,2′-azobis(2-methylpropanenitrile)), VAZO 67 (2,2′-azobis(2-methylbutanenitrile)), and VAZO 88 (2,2′-azobis(cyclohexanecarbonitrile)), all available from E.I. DuPont deNemours Corp. (Wilmington, Del.).

When the initiator(s) have been mixed into the monomers, there will be a temperature above which the mixture begins to react substantially (rate of temperature rise typically greater than about 0.1° C./min for essentially adiabatic conditions). This temperature, which depends on factors including the monomer(s) being reacted, the relative amounts of monomer(s), the particular initiator(s) being used, the amounts of initiator(s) used, and the amount of any polymer, non-reactive diluent or filler, and/or any solvent in the reaction mixture, will be defined herein as the “runaway onset temperature”.

As an example, as the amount of an initiator is increased, its runaway onset temperature in the reaction mixture will decrease. At temperatures below the runaway onset temperature, the amount of polymerization proceeding will be practically negligible. At the runaway onset temperature, assuming the absence of reaction inhibitors and the presence of essentially adiabatic reaction conditions, the free radical polymerization begins to proceed at a meaningful rate and the temperature will start to accelerate upwards, commencing the runaway reaction.

According to the present disclosure, a sufficient amount of initiator(s) typically is used to carry the polymerization to the desired temperature and conversion. If too much initiator(s) is used, an excess of low molecular weight polymer will be produced thus broadening the molecular weight distribution. Low molecular weight components can degrade the oligomer composition performance. If too little initiator is used, the polymerization will not proceed appreciably and the reaction will either stop or will proceed at an impractical rate.

The preferred amount of an individual initiator used depends on factors including its efficiency, its molecular weight, the molecular weight(s) of the monomer(s), the heat(s) of reaction of the monomer(s), the types and amounts of other initiators included, etc. Typically the total initiator amount used is in the range of about 0.0005 weight % to about 0.5 weight % and preferably in the range of about 0.001 weight % to about 0.1 weight % based on the total weight of monomer(s).

### Optional Additives

In any of the foregoing embodiments, one or more additives may optionally be added to the composition. Such optional additives include, for example, organic solvents, non-reactive diluents and/or fillers, as described further below. Other optional additives include chain transfer agents, ultraviolet (UV) light stabilizers, antioxidants, silane condensation catalysts, rheology modifiers, slip agents, anti-blocking agents, and the like.

Organic Solvents

As indicated previously, the use of an organic solvent is optional in the polymerization method of the present disclosure. In some exemplary embodiments, an organic solvent may be advantageously used for reasons of decreasing the viscosity during the reaction to allow for efficient stirring and heat transfer. The organic solvent, if used in the free radical polymerization, may be any substance which is liquid in a temperature range of about −10° C. to about 50° C., has a dielectric constant above about 2.5, does not interfere with the energy source or catalyst used to dissociate the initiator to form free radicals, is inert to the reactants and product, and will not otherwise adversely affect the reaction.

Organic solvents useful in the polymerization process typically possess a dielectric constant greater than about 2.5. The requirement that the organic solvent possess a dielectric constant above about 2.5 is to ensure that the polymerization mixture remains substantially homogeneous during the course of the reaction, allowing for the desired reaction between the siloxane macromer, the crystalline (meth)acrylate monomer, the initiator and any optional free radically polymerizable polar monomer, to occur.

Preferably, the organic solvent is a polar organic solvent having a dielectric constant ranging from about 4 to about 30 for in order to provide the best solvating power for the polymerization mixture.

Suitable polar organic solvents include but are not limited to esters such as ethyl acetate, propyl acetate and butyl acetate; ketones such as methyl ethyl ketone and acetone; alcohols such as methanol and ethanol; and mixtures of one or more of these. A presently preferred organic solvent is ethyl acetate.

Other organic solvents may also be useful in combination with these polar organic solvents. For example, although aliphatic and aromatic hydrocarbons are not generally useful by themselves as solvents, since they may lead to the precipitation of the vinyl polymeric segment from solution, resulting in a non-aqueous dispersion polymerization, such hydrocarbon solvents may be useful when admixed with other more polar organic solvents, provided that the net dielectric constant of the mixture is greater than about 2.5.

The amount of organic solvent, if used, is generally about 30 to 80 percent by weight (wt. %) based on the total weight of the reactants and solvent. Preferably, the amount of organic solvent (if used) ranges from about 40 to about 65 wt. % based upon the total weight of the reactants and solvent for reasons of yielding fast reaction times and high molecular weight at appropriate product viscosities. In some exemplary embodiments, the organic solvent is present in an amount from about 40 wt. % to about 80 wt. % of the composition. In such exemplary embodiments, the oligomer is preferably formed by solution polymerization, more preferably by solution polymerization of a substantially homogeneous mixture.

The (co)polymer is preferably formed by bulk polymerization in the absence of added organic solvents. Thus, in certain presently preferred exemplary embodiments, the composition is substantially free of any organic solvent. However, in some exemplary embodiments, solution polymerization may be carried out. The polymerization may also be carried out by other well known techniques such as suspension or emulsion polymerization.

Non-Reactive Diluents

Non-reactive diluent may be used in some exemplary embodiments to reduce the adiabatic temperature rise during reaction by absorbing a portion of the heat of reaction. Non-reactive diluents may also reduce the viscosity of the oligomer composition and/or advantageously affect the final properties of the oligomer composition. Advantageously, the non-reactive diluent can remain in the oligomer composition in its usable form.

Suitable non-reactive diluents are preferably non-volatile (that is, they remain present and stable under polymerization and processing conditions) and are preferably compatible (i.e., miscible) in the mixture. “Non-volatile” diluents typically generate less than 3% VOC (volatile organic content) during polymerization and processing. The term “compatible” refers to diluents that exhibit no gross phase separation from the base copolymer when blended in the prescribed amounts, and that, once mixed with the base copolymer, do not significantly phase separate from the base copolymer upon aging. Non-reactive diluents include, for example, materials which can raise or lower the glass transition temperature (T_{g}) of the oligomer composition, including tackifiers such as synthetic hydrocarbon resins and plasticizers such as phthalates.

The non-reactive diluent can also serve as a non-volatile “solvent” for incompatible mixtures of comonomers. Such incompatible comonomer mixtures typically require a volatile reaction medium, such as an organic solvent to promote effective copolymerization. Unlike volatile reaction media, the non-reactive diluent does not have to be removed from the oligomer composition.

Fillers

Useful fillers are preferably non-reactive such that they do not contain free radically reactive ethylenically unsaturated groups that can co-react with the comonomers of the base oligomer, or functionalities that significantly inhibit monomer polymerization or chain transfer during the polymerization of monomers. Fillers can, for example, be used to reduce the cost of the final (co)polymer formulation.

Useful fillers include, for example, clay, talc, dye particles and colorants (for example, TiO₂ or carbon black), glass beads, metal oxide particles, silica particles, and surface-treated silica particles (such as Aerosil R-972 available from Degussa Corporation, Parsippany, N.J.). The filler can also comprise conductive particles (see, for example, U.S. Patent Application Pub. No. 2003/0051807) such as carbon particles or metal particles of silver, copper, nickel, gold, tin, zinc, platinum, palladium, iron, tungsten, molybdenum, solder or the like, or particles prepared by covering the surface of these particles with a conductive coating of a metal or the like.

It is also possible to use non-conductive particles of a polymer such as polyethylene, polystyrene, phenol resin, epoxy resin, acryl resin or benzoguanamine resin, or glass beads, silica, graphite or a ceramic, whose surfaces have been covered with a conductive coating of a metal or the like. Presently preferred fillers include, for example, hydrophobic fumed silica particles, electrically conductive particles, and metal oxide particles.

Appropriate amounts of filler will be familiar to those skilled in the art, and will depend upon numerous factors including, for example, the monomer(s) utilized, the type of filler, and the end use of the oligomer composition. Typically, filler will be added at a level of about 1% to about 50% by weight (preferably, about 2% to about 25% by weight), based upon the total weight of the reaction mixture.

### Methods of Making the Oligomer Compositions

The present disclosure also provides a process for making the composition including the at least one moisture-curable, semi-crystalline (meth)acrylic oligomer, the process including chemically reacting a reaction mixture containing an alkyl (meth)acrylate having a carbon number from 16 to 30, an alkyl (meth)acrylate having a carbon number from 1 to 15, and an alkoxysilane compound including a (meth)acryloyl-functionality or a mercapto-functionality, wherein the alkoxy silane compound includes alkyl moieties containing from 1-3 carbon atoms. Optionally, an organic solvent or reactive diluent may be added to the reaction mixture, particularly when it is desirable to carry out the reaction under essentially adiabatic conditions. Preferable, the organic solvent or reactive diluent is selected to by an essentially non-volatile organic compound (i.e., low VOC).

However, in some particular embodiments, we find it advantageous to use 100% solids polymerization methods since they provide high performance materials without the need for solvent as a processing aid. The optional use of 100% solids for the synthesis of the moisture curable semi-crystalline (meth)acrylic oligomers also improves the cost effectiveness and environmental friendliness of the synthesis process, since the use of volatile organic solvents is not required to manufacture the moisture curable semi-crystalline (meth)acrylic oligomers.

Although the moisture curable semi-crystalline (meth)acrylic oligomers are advantageously prepared at 100% solids, they can also be prepared using other technologies such as solution or dispersion polymerization.

The moisture curable semi-crystalline (meth)acrylic oligomers can be prepared by any of the free radical polymerization techniques known to those skilled in the art. The oligomers are typically prepared by the addition polymerization of one or more ethylenically-unsaturated linear or branched (meth)acrylic monomers having a carbon number of less than 16, with one or more ethylenically-unsaturated linear (meth)acrylic monomers with a carbon number of 16 or greater, in the presence of 3-mercaptoalkyl trimethoxy silane(s), and any number of other ethylenically unsaturated co-monomers, which preferably are (meth)acrylic co-monomers.

In carrying out the reaction to form the moisture-curable, semi-crystalline (meth)acrylic oligomer(s), the free radically polymerizable crystalline (meth)acrylate compound(s), the vinyl-functional (meth)acrylic compound(s), the alkoxysilane, the initiator, and any optional solvent, reactive diluents and/or filler, may be charged into an appropriate reaction vessel.

If photolysis is conducted to decompose the initiator, the reactants and any solvent employed are charged into an energy source-transparent vessel and therein subjected to the energy source. If the energy source is ultraviolet light radiation, a suitable ultraviolet light-transparent vessel is used.

If thermolysis is used to decompose the initiator, the reactants and any solvent employed are charged into a suitable glass or metal reactor and therein subjected to the thermal energy source. If catalysis is used to decompose the initiator, a glass or metal reactor can also be utilized.

The reaction is preferably conducted in a vessel with agitation to permit uniform exposure of the reactants to the energy source. While most of the reactions have been conducted by employing a batch process, it is possible to utilize the same technology in a continuous polymerization operation.

Reaction times on the order of 10 to 40 hours have been found to be typical, depending upon the amount and type of solvent used, the amount and type of initiator used, temperatures or photolytic energy supplied, and the nature of the free radically polymerizable monomer.

The moisture curable semi-crystalline (meth)acrylic oligomers formed according to the methods of the present disclosure may, when necessary or desirable, be blended with a compatible modifier in order to optimize physical properties. The use of such modifiers is common in the art. For example, it may be desirable to include such materials as pigments, fillers, stabilizers, or various polymeric additives.

### Method of Applying the Oligomer Compositions to a Substrate

The present disclosure further describes a process for making an article, including applying the moisture-curable, semi-crystalline (meth)acrylic oligomer composition to a major surface of a substrate, and curing the moisture-curable, semi-crystalline (meth)acrylic oligomer by reaction with a plurality of hydroxyl groups present on the major surface of the substrate.

Substrates

In some exemplary embodiments of adhesive articles as described further below, the substrate is selected from a (co)polymeric film, paper, woven cloth, non-woven cloth, and a web comprised of non-woven (co)polymeric fibers. In some advantageous embodiments, the substrate is a (co)polymeric film.

In certain particularly advantageous embodiments, the substrate is selected to have a plurality of hydroxyl groups on a major surface of the substrate with which the alkoxy silane may react, thereby chemically anchoring (i.e., covalently bonding) the semi-crystalline (meth)acrylic oligomer to the substrate surface.

Suitable substrates having a plurality of hydroxyl groups on a major surface include glass, ceramics, metals (including metal foils), metal oxides, cellulose (e.g., paper, including Kraft paper and supercalendered or glassine Kraft paper), cellulose acetate, ethyl cellulose, poly(ethylene terephthalate), poly(ethylene naphthalate), polycarbonate, polyolefins (e.g., polypropylene, biaxially-oriented polypropylene, polyethylene, polybutylene), polyamides), and combinations thereof.

Various surface treatment methods (e.g., flame treatment, corona treatment, plasma treatment, coating with primers such as metal oxide sols or hydroxylated primers) may also be used to provide substrates having a plurality of hydroxyl groups on a major surface

In some particularly advantageous embodiments, the substrate is a polyethylene terephthalate (PET) film. In other particularly advantageous embodiments, the substrate is Kraft paper, or supercalendered or glassine Kraft paper. In some embodiments, multilayer substrates may be used.

One presently preferred type of substrate is that which is used for pressure sensitive adhesive articles, such as tapes, labels, bandages, and the like. The semi-crystalline (meth)acrylic oligomer may be applied to at least one major surface of suitable flexible or inflexible backing materials before drying is initiated. Primers known in the art can be applied to the substrate to aid in the adhesion of the semi-crystalline (meth)acrylic oligomer to the substrate, although they are generally not necessary. Woven, nonwoven or knitted materials are typically used as backings in PSA medical tapes. Examples of suitable backings include nonwoven fabrics such as carded, spun-bonded, spun-laced, air-laid, and stitch-bonded fabrics; woven fabrics having sufficient stretch to benefit from the use of an elastomer; and knitted fabrics such as warp-knitted and weft-knitted materials.

Preferred backings exhibit a desired combination of properties such as moisture vapor transmission, softness, conformability, yield modulus, texture, appearance, processability, and strength. The particular combination of properties is typically determined by the desired application. For example, for many uses in the medical area, the fabric will have a low yield modulus and will be of sufficient strength for the desired application and for dispensation in a roll or pad form.

Flexible backings can be of woven fabric formed of threads of synthetic fibers or natural materials such as cotton or blends of these. Alternatively, backing materials may be nonwoven fabric such as air laid webs of synthetic or natural fibers or blends of these. In addition, suitable backings can be formed of metal, foils, or ceramic sheet material.

In exemplary release liner or PSA tape article embodiments, the substrate is advantageously selected from a polymeric film, paper, woven cloth, non-woven cloth, and a web comprised of non-woven polymeric fibers. In some particular such exemplary embodiments, the substrate is a polymeric film. Suitable polymeric films include, for example, polyester films such as polyethylene terephthalate (PET), polylactic acid (PLA) and polyethylene naphthalate (PEN); polyolefin films such as polyethylene and polypropylene; polyamide films such as nylon; polyimide films such as KAPTON (available from DuPont deNemours Corp., Wilmington, Del.); cellulose acetate; polyvinylchloride; polytetrafluoroethylene and the like.

Suitable rigid substrates include but are not limited to glass, wood, metals, treated metals (such as those comprising automobile and marine surfaces), (co)polymeric films and surfaces, and composite materials such as fiber reinforced plastics.

In certain exemplary embodiments, the substrate may be smooth or textured, e.g., embossed. In some exemplary embodiments, the substrate is embossed after curing the moisture-curable, semi-crystalline oligomer composition.

Application Methods

Methods of the present disclosure involve applying a layer comprising a moisture-curable, semi-crystalline (meth)acrylic oligomer(s) to a major surface of a substrate. Advantageously, the materials comprising the oligomer layer are fluids. Generally, lower molecular weight, lower viscosity oligomers are preferred fluids for application to a substrate surface (e.g., by spraying or coating).

In certain exemplary embodiments, applying the moisture-curable, semi-crystalline (meth)acrylic oligomer composition to the major surface of the article includes coating the moisture-curable, semi-crystalline (meth)acrylic oligomer composition onto the major surface of the substrate. In further exemplary embodiments, the process includes heating the article to accelerate reaction of the moisture-curable, semi-crystalline (meth)acrylic oligomer composition. The cured oligomer composition provides a release layer is used as a surface protection layer in a release liner or as a low adhesion backsize (LAB) in an adhesive article, for example, an adhesive tape.

In order to obtain the low thicknesses generally desirable for some LAB or primer coatings, e.g., silicone release materials or primers for silicone adhesives, it is often necessary to dilute high molecular weight materials with solvents in order to coat or otherwise apply them to a substrate. In some embodiments, it is advantageous to use low molecular weight, low viscosity oligomers according to the present disclosure to avoid the need to add organic solvents to the coating composition. In such embodiments, it may be useful to use oligomers compatible with common solventless coating operations, including, e.g., those oligomer fluids having a viscosity at 25° C. and a shear raste of 100 sec⁻¹ of no greater than 10,000 mPa-s, no greater than 5,000 mPa-s, no greater than 4,000 mPa-s, no greater than 2,500 mPa-s, no greater than 1,000 mPa-s, or no greater than 500 mPa-s or even 100 mPa-s.

In general, depending on the selected material comprising the layer, including its viscosity, any known coating method may be used. Exemplary coating methods include roll coating, Mayer rod coating, knife coating, curtain coating, slide coating, spray coating, electrospray coating, dip coating, gravure coating, bar coating, vapor coating, and the like. The low viscosity oligomer mixtures are advantageously coated by means specifically adapted to deliver thin layers, in some cases through the advantageous use of precision roll coaters and electrospray methods such as those described in U.S. Pat. Nos. 4,748,043 and 5,326,598 (both to Seaver et al.).

Higher viscosity mixtures which can be coated to higher thickness (e.g., up to about 500 μm) can be provided by selecting higher molecular weight oligomer compositions. Low viscosity oligomer compositions can also be thickened with adjuvants (e.g., thickeners), including but not limited to particulate fillers such as colloidal silica and the like, prior to coating, although this is not presently preferred.

In some exemplary embodiments of any of the foregoing, the oligomer layer is applied at a thickness of about 0.1 (+/−0.05) micrometer (μm) to about 5 (+/−0.1) μm prior to irradiation with the short wavelength polychromatic light source. In certain exemplary embodiments, the layer is applied at a thickness of at least about 0.2 (+/−0.05) μm, 0.3 (+/−0.05) μm, 0.4 (+/−0.05) μm, or even 0.5 (+/−0.05) μm; to about 4 (+/−0.1) μm, 3 (+/−0.1) μm, 2 (+/−0.1) μm, or even 1 (+/−0.1) μm, prior to curing.

In other exemplary embodiments, the at least partially cured layer or even the fully cured layer may have a thickness of 0.1 (+/−0.05) micrometer (μm) to about 50 (+/−0.1) μm. In certain exemplary embodiments, the at least partially cured layer or even the fully cured layer has a thickness of at least about 0.2 (+/−0.05) μm, 0.3 (+/−0.05) μm, 0.4 (+/−0.05) μm, or even 0.5 (+/−0.05) μm; to about 40 (+/−0.1), 30 (+/−0.1), 25 (+/−0.1), 20 (+/−0.1), 15 (+/−0.1), 10 (+/−0.1), 5 (+/−0.1), 4 (+/−0.1) μm, 3 (+/−0.1) μm, 2 (+/−0.1) μm, or even 1 (+/−0.1) μm.

In any of the foregoing exemplary embodiments, applying the oligomer layer to the surface of the substrate may include applying a discontinuous coating. In other words, the layer need not cover the entire major surface of the substrate, and only a portion of the substrate surface may be covered by the layer. For example, the layer may be applied to the substrate as a single strip or stripe, or as a plurality of strips or stripes, as a plurality of dots, or in any other discernible pattern.

The coating can be dried at room temperature, at an elevated temperature, or a combination thereof, provided that the backing material can withstand the elevated temperature. Typically, the elevated temperature is about 60° C. to about 130° C.

The resulting cured oligomer may be used as a release coating (e.g., an LAB) to provide an effective release for a wide variety of conventional pressure-sensitive adhesives such as natural rubber-based, acrylic, tackified block copolymer, silicone, and other synthetic film-forming elastomeric materials. Alternatively, the resulting cured oligomer may be used as a primer layer for an overlaid adhesive layer, which advantageously is selected to be a low surface energy (e.g., silicone) adhesive, as described further below.

In one additional aspect, the present disclosure provides a process for making any of the foregoing articles, including applying the moisture-curable, semi-crystalline (meth)acrylic oligomer composition to a major surface of a substrate, and curing the moisture-curable, semi-crystalline (meth)acrylic oligomer by reaction with a plurality of hydroxyl groups present on the major surface of the substrate.

In certain such exemplary embodiments, applying the moisture-curable, semi-crystalline (meth)acrylic oligomer composition to the major surface of the article includes coating the moisture-curable, semi-crystalline (meth)acrylic oligomer composition onto the major surface of the substrate, and curing the moisture-curable, semi-crystalline (meth)acrylic oligomer by reaction with a plurality of hydroxyl groups present on the major surface of the substrate. Optionally, the substrate may be heated to accelerate curing of the moisture-curable, semi-crystalline (meth)acrylic oligomer composition.

In further exemplary embodiments, the process includes heating the article to accelerate reaction of the moisture-curable, semi-crystalline (meth)acrylic oligomer composition. The cured oligomer composition may provide a release layer suitable for use as a surface protection layer in a release liner or as a low adhesion backsize (LAB) in an adhesive article, for example, an adhesive tape. Alternatively, the cured oligomer may be used as a primer layer to adhere a low surface energy adhesive to the substrate.

### Adhesive Articles

Moisture curable semi-crystalline (meth)acrylic oligomer composition(s) of the present disclosure generally can be used as a coating for a solid substrate, which may be a sheet, a fiber, or a shaped object. Thus, in exemplary embodiments, the present disclosure describes an article including any of the foregoing semi-crystalline (meth)acrylic oligomers applied to a first major surface of a substrate.

Cured semi-crystalline (meth)acrylic oligomer composition(s) prepared according to the methods of the present disclosure may be used in any of a wide variety of applications, including, e.g., as release layers, low adhesion backsize (LAB) layers, primer layers for low surface energy adhesive layers, and the like. The disclosed moisture-curable, semi-crystalline (meth)acrylic oligomer composition(s) can also be used advantageously as a coating, for example as a primer or adhesion promoting layer, applied to a substrate.

Thus, in some exemplary embodiments, the present disclosure provides an article including a low adhesion backsize (LAB), or a primer for a low surface energy adhesive applied to a major surface of a substrate. The LAB or primer includes a moisture-curable, semi-crystalline (meth)acrylic oligomer of any of the foregoing compositions, and more particularly, a reaction product of an at least partially cured moisture-curable, semi-crystalline (meth)acrylic oligomer of any of the foregoing compositions.

In certain exemplary embodiments, the article is an adhesive article, and preferably a pressure-sensitive adhesive (PSA) article. In some such embodiments, the adhesive article includes an adhesive, more preferably a PSA, even more preferably a silicone PSA, applied to a major surface of the substrate. In some exemplary embodiments, the adhesive may be applied on a major surface of the substrate opposite to the major surface of the substrate on which the semi-crystalline (meth)acrylic oligomer is applied and cured by reaction with a plurality of hydroxyl groups present on the major surface of the substrate.

In one such exemplary embodiment, the adhesive article is a liner-less adhesive tape, and the cured semi-crystalline (meth)acrylic oligomer acts as a low adhesion backsize (LAB). In other exemplary embodiments, the adhesive article includes a primer layer comprising the foregoing semi-crystalline (meth)acrylic oligomer cured by reaction with a plurality of hydroxyl groups present on the major surface of the substrate, and an adhesive layer applied over and adjacent to the primer layer on the major surface of the substrate. Advantageously, the adhesive is a low surface energy adhesive, such as an adhesive derived from a polysiloxane (i.e., a silicone adhesive).

In certain such exemplary adhesive article embodiments, the substrate is selected from a (co)polymeric film, paper, woven cloth, non-woven cloth, and a web comprised of non-woven (co)polymeric fibers. In some advantageous embodiments, the substrate is a (co)polymeric film.

In certain particularly advantageous embodiments, the substrate is selected to have a plurality of hydroxyl groups on a major surface of the substrate with which the alkoxy silane may react, thereby chemically anchoring (i.e., covalently bonding) the semi-crystalline (meth)acrylic oligomer to the substrate surface. In some particularly advantageous embodiments, the substrate is a polyethylene terephthalate (PET) film. In other particularly advantageous embodiments, the substrate is Kraft paper, or supercalendered or glassine Kraft paper.

In some embodiments, the substrate may be coated on one or both sides with a release material. Thus, in certain such embodiments, the substrate may be a release liner, and the article may be a dual-linered transfer tape.

In some embodiments, the substrate may be permanently bonded to the adhesive and the adhesive article may be, e.g., a tape or a label. Presently preferred adhesive articles are tapes, labels, wound dressings, and medical grade tapes. For example, one preferred wound dressing includes a polymeric film that is extremely thin, flexible, and supple such that it is conformable. Medical grade tapes, or other articles, are typically “breathable,” in that they are moisture vapor permeable due to the use of a porous backing. Such tapes may also include a variety of characteristics, such as softness and conformability. In one exemplary advantageous embodiment, the article is a liner-less adhesive tape. In some embodiments, liner-less adhesive tape may be self wound, and the opposite (exposed) surface of the adhesive will come into contact with the LAB on the opposite major surface of substrate. In use, the surface of the liner-less adhesive tape is applied to a surface, for example, a biological surface, e.g., human skin, thereby adhering substrate to the biological surface.

In general, the release materials may be independently selected, and may be the same or different release materials. In some embodiments, both release materials are prepared according to the methods of the present disclosure. In some embodiments, self-wound adhesive articles may be prepared from such two-sided release liners.

In some embodiments, in addition to release liner, the adhesive article further comprises adhesive releasably adhered to the cured oligomer composition(s), forming a transfer tape. In some embodiments, the adhesive article further comprises a second substrate adhered to an adhesive opposite the cured oligomer composition(s). In some embodiments, one or more primer layers may be included. For example, in some embodiments, a primer layer may be located on and adjacent to one or both major surfaces of a substrate, and an adhesive layer may be located on and adjacent to the primer layer on one or both of the major surfaces.

Adhesives

Generally, any known adhesive(s) may be used in the adhesive articles mad according to the present disclosure. Advantageously, the adhesive layer may comprise one or more adhesive(s) selected from a pressure sensitive adhesive, a hot melt adhesive, a radiation curable adhesive, a tackified adhesive, a non-tackified adhesive, a synthetic rubber adhesive, a natural rubber adhesive, a (meth)acrylic (co)polymer adhesive, a silicone adhesive, and a polyolefin adhesive. In some embodiments, the adhesive may comprise a (meth)acrylic (co)polymer adhesive, which is preferably a pressure sensitive adhesive.

In certain presently preferred exemplary embodiments, the article is a pressure sensitive adhesive (PSA) article. Pressure sensitive adhesives can be any of a variety of materials known and are generally applied to a backing material. Generally, pressure sensitive adhesives are used in tapes wherein a tape includes a backing (or substrate) and a pressure sensitive adhesive. A pressure sensitive adhesive adheres with no more than applied finger pressure and can be permanently tacky.

Pressure sensitive adhesives can be used with primers, tackifiers, plasticizers, and the like. The pressure sensitive adhesives are preferably sufficiently tacky in their normal dry state, and have a desired balance of adhesion, cohesion, stretchiness, elasticity and strength for their intended use. PSA tapes can be used in a wide variety of applications such as to adhere two surfaces together (e.g., flaps of packing material) or in the medical area (e.g., wound dressings). In the latter case, the PSA is a coating on the skin-facing side of the backing. Such PSAs are preferably “hypoallergenic” in that they exhibit acceptable performance in the 21-day Draize test on human subjects. Presently preferred PSAs are silicone PSAs.

In other exemplary embodiments, the adhesive article includes a low surface energy adhesive, more preferably a low surface energy PSA, even more preferably a low surface energy silicone (i.e., siloxane (co)polymer) PSA applied over and adjacent to a primer layer including the moisture-curable, semi-crystalline (meth)acrylic oligomer, the primer layer being applied to a first major surface of the substrate.

The use of silicone pressure sensitive adhesives, e.g., for adhering a substrate to skin, is known in the art and many examples are commercially available. However, known silicone PSA tapes generally require a release liner. A liner-less silicone PSA tape is highly desirable to avoid problems in dealing with removal and disposal of the liner, or tearing the tape and the liner into strips, before applying the tape to a surface. Such a liner-less silicone PSA tape would be especially useful for medical adhesive tapes, wound dressings, and the like.

Furthermore, some properties of PSAs limit their application for adhesion to skin. For instance, skin damage may result during the removal of a PSA that exhibits too high a level of adhesive strength. Alternatively, if the adhesive strength is reduced, the PSA may lack sufficient holding power to be useful or will lose the room temperature tackiness that makes easy application of the adhesive possible. Additionally PSAs that are relatively rigid or non-conformable compared to skin typically result in considerable patient discomfort during use. Also, even adhesives that have a measured low peel adhesion to skin may cause discomfort during removal, e.g., if the adhesive becomes entangled with hair.

The various moisture-curable, semi-crystalline (meth)acrylic oligomer composition(s), articles and methods of the present disclosure, in some exemplary embodiments, advantageously provide increased hydrophobicity, improved water repellency, ultra-low volatile organic compounds (VOC) performance at 100% solids, efficient manufacturing, easy handling, low viscosity and ease of coating using a wide variety of application methods, good shelf stability (compared to comparable polymeric LAB compositions), and low cost.

The operation of various exemplary embodiments of the present disclosure will be further described with regard to the following non-limiting detailed examples. These examples are offered to further illustrate the various specific and preferred embodiments and techniques. It should be understood, however, that many variations and modifications may be made while remaining within the scope of the present disclosure.

### EXAMPLES

### Materials

Unless otherwise noted, all parts, percentages, ratios, etc. in the Examples and the rest of the specification are by weight. The term “pph” denotes parts per hundred parts of a composition or mixture. In addition, Table 1 provides abbreviations and a source for all materials used in the Examples, which follow.

TABLE 1

| Abbreviation | Description | Source |
|---|---|---|
| VAZO 52 | 2,2′-azobis(2,4 | DuPont, Wilmington, |
| | dimethylpentanenitrile) | DE |
| VAZO 67 | 2,2′-azobis(2- | DuPont, Wilmington, |
| | methylbutanenitrile) | DE |
| VAZO 88 | 2,2′-azobis(cyclo- | DuPont, Wilmington, |
| | hexanecarbonitrile) | DE |
| IRGANOX | tetrakis(methylene(3,5-di- | Ciba Specialty |
| 1010 | tert-butyl-4-hydroxyhydro- | Chemicals, Tarrytown, |
| | cinnamate))methane | NY |
| LUPERSOL | 2,5-dimethyl-2,5 Di-(t- | Elf Atochem, |
| 101 | butylperoxy)hexane | Philadelphia, PA |
| LUPERSOL | 2,5-dimethyl-2,5-Di-(t- | Elf Atochem, |
| 130 | butylperoxy)hex-3-yne | Philadelphia, PA |
| AA | (Meth)acrylic Acid | Dow Chemical, |
| | | Midland, MI |
| MMA | Methyl methacrylate | Rohm and Haas, |
| | | Philadelphia, PA |
| EtOAc | Ethyl acetate | EMD Chemicals, |
| | | Gibbstown, NJ |
| IPA | Isopropanol | J T Baker, Center |
| | | Valley, PA |
| ODA | Octadecyl acrylate | San Esters, New York, |
| | | NY |
| BHA | Behenyl Acrylate | Cognis, Mannheim, |
| | | Germany |
| IBOA | Isobornyl Acrylate | San Esters, New York, |
| | | NY |
| AN | Acrylonitrile | INEOS USA, Lima, OH |
| QMA | 2-(N,N-dimethylamino)ethyl- | Ciba Specialty |
| | acrylate salt with methylchloride | Chemical, Tarrytown, |
| | | NY |
| DMAEMA | 2-(N,N-Dimethylamino)ethyl- | 3M, St. Paul, MN |
| | acrylate, salt with | |
| | hexadecylbromide | |
| A-189 | (3-Mercaptopropyl)tri- | Alfa Aesar, Ward Hill, |
| | methoxysilane | MA |
| IOA | Isooctylacrylate | 3M, St. Paul, MN |
| MEHQ | 4-methoxyphenol | Sigma-Aldrich, St. |
| | | Louis, MO |
| Q2-5211 | Q2-5211 Silicone Surfactant | Dow-Corning, Midland, |
| | | MI |
| IRGACURE | 2,2-Dimethoxy-1,2-diphenyl- | Ciba Specialty |
| 651 | ethan-1-one | Chemicals, Tarrytown, |
| | | NY |

### Test Methods

The peel force and readhesion were measured using an Instrumentors, Inc. (Strongsville, Ohio) Slip Peel Tester at a rate of 90 inches/min (228.6 cm/min) and a peel angle of 180 degrees with a test time of 5 seconds. The tapes were peeled from the release coated PET and the average peel force was measured. After removal from the release coated PET, the tapes were rolled down onto a clean glass plate using 2 passes of a 5 lb (11 kg) roller and the average force to remove the tapes (readhesion) were also measured. The glass plate was cleaned by wiping with heptanes, isopropanol (IPA) and methyl ethyl ketone (MEK) between each test.

Three measurements of average peel force and readhesion were measured for each sample. The control peel force was measured by peeling the tape for its own LAB coated film and control adhesion to glass were measured for tapes unwound directly from the tape rolls, again the reported vales are average of triplicate.

### Synthesis of (Meth)Acrylic Oligomers

### Example 1

### ODA/MMA/A-189 70/25/5 Weight Percent

A solution of reactive monomers and solvents was prepared by adding them a glass bottle. Specifically, 10.5 grams of octadecyl acrylate (ODA), 3.8 grams of methyl methacrylate (MMA), 0.8 grams of (3-mercaptopropyl) trimethoxysilane (A-189), 0.15 grams of 2,2′-azobis(2-methylbutanenitrile) (VAZO 67), 24.5 grams of ethyl acetate (EtOAc), and 10.5 grams of isopropanol (IPA) were added. The ODA was heated to 65° C. in order to add it conveniently as a molten liquid, the other ingredients were added at room temperature. The mixture was gently shaken in order to prepare a homogenous solution. The bottle was purged with nitrogen, sealed and tumbled in a constant temperature water bath at 65° C. for 24 hours.

### Example 2

### ODA/MMA/A-189 60/30/10 Weight Percent

The procedure of Example 1 was repeated. The charges of components were as follows: 9.0 g ODA, 4.5 g MMA, 1.5 g A-189, 0.15 g VAZO 67, 24.5 g of EtOAc, and 10.5 g IPA.

### Example 3

### ODA/MMA/A-189 70/20/10 Weight Percent

The procedure of Example 1 was repeated. The charges of components were as follows: 10.5 g ODA, 3.0 g MMA, 1.5 g A-189, 0.15 g VAZO 67, 24.5 g of EtOAc, and 10.5 g IPA.

### Example 4

### ODA/AN/A-189 70/20/10 Weight Percent

The procedure of Example 1 was repeated, except that acrylonitrile (AN was added in place of the MMA. The charges of components were as follows: 10.5 g ODA, 3.0 g AN, 1.5 g A-189, 0.15 g VAZO 67, 24.5 g of EtOAc, and 10.5 g IPA.

### Examples of (Meth)Acrylic Oligomers According to the Present Disclosure with Solventless Preparation in an Adiabatic Reactor

### Example 5

### ODA/MMA/A-189 (60/35/5) Weight Percent

An adiabatic reaction apparatus known as VSP2, equipped with a 316 stainless steel test can, both commercially available from Fauske and Associates Inc, of Burr Ridge Ill., was charged with 70 grams of a mixture of ODA, MMA, and A-189 in a weight percent ratio of 60/35/5 respectively, and further with 0.1 pph of Irganox 1010, and 0.02 pph of VAZO 52. The reactor was sealed and purged of oxygen and then held at approximately 100 psig (793 kPa) of nitrogen pressure. The reaction mixture was heated to 60° C., and the reaction proceeded adiabatically. During this reaction, a peak temperature of approximately 100° C. was observed. When the reaction was complete, the mixture was cooled to below 50° C.

To 70.00 grams of the reaction product of the first step was added 0.02 pph of VAZO 52, 0.004 pph of VAZO 67, 0.006 pph of VAZO 88, 0.006 pph of LUPERSOL 101, and 0.008 of LUPERSOL 130. (These components were added as a 0.7 gram solution dissolved in ethyl acetate). The reactor was again sealed and purged of oxygen and held at 100 psig (793 kPa) nitrogen pressure. The reaction mixture was heated to 60° C. and the reaction proceeded adiabatically. During this reaction, a peak temperature of approximately 145° C. was observed.

### Example 6

### ODA/MMA/A-189 (40/55/5) Weight Percent

The procedure of Example 5 was repeated, except for the following particulars: In the first reaction, the adiabatic reaction apparatus was charged with 70 grams of a mixture of ODA, MMA, and A-189 in a weight percent ratio of 40/55/5 respectively, and further with 0.1 pph of Irganox 1010, and 0.05 pph of VAZO 52. During the first reaction, a peak temperature of approximately 120° C. was observed.

To 70.00 grams of the reaction product of the first step was added 0.05 pph of VAZO 52, 0.01 pph of VAZO 67, 0.01 pph of VAZO 88, 0.006 pph of LUPERSOL 101, and 0.008 of LUPERSOL 130. (These components were added as a 0.7 gram solution dissolved in ethyl acetate). The reactor was again sealed and purged of oxygen and held at 100 psig (793 kPa) nitrogen pressure. The reaction mixture was heated to 60° C. and the reaction proceeded adiabatically. During this reaction, a peak temperature of approximately 120° C. was observed.

### Example 7

### ODA/IBOA/A-189 (60/35/5) Weight Percent

The procedure of Example 5 was repeated, except for the following particulars: In the first reaction, the adiabatic reaction apparatus was charged with 70 grams of a mixture of ODA, isobornyl acrylate (IBOA), and A-189 in a weight percent ratio of 60/35/5 respectively, and further with 0.1 pph of Irganox 1010, and 0.001 pph of VAZO 52. During the first reaction, a peak temperature of approximately 90° C. was observed.

To 70.00 grams of the reaction product of the first step was added 0.018 pph of VAZO 52, 0.004 pph of VAZO 67, 0.01 pph of VAZO 88, 0.006 pph of LUPERSOL 101, and 0.008 of LUPERSOL 130. (These components were added as a 0.7 gram solution dissolved in ethyl acetate). The reactor was again sealed and purged of oxygen and held at 100 psig (793 kPa) nitrogen pressure. The reaction mixture was heated to 60° C. and the reaction proceeded adiabatically. During this reaction, a peak temperature of approximately 108° C. was observed.

### Example 8

### ODA/IBOA/A-189 (40/55/5) Weight Percent

The procedure of Example 5 was repeated, except for the following particulars: In the first reaction, the adiabatic reaction apparatus was charged with 70 grams of a mixture of ODA, IBOA, and A-189 in a weight percent ratio of 40/55/5 respectively, and further with 0.1 pph of Irganox 1010, and 0.001 pph of VAZO 52. During the first reaction, a peak temperature of approximately 112° C. was observed.

To 70.00 grams of the reaction product of the first step was added 0.018 pph of VAZO 52, 0.004 pph of VAZO 67, 0.006 pph of VAZO 88, 0.006 pph of LUPERSOL 101, and 0.008 of LUPERSOL 130. (These components were added as a 0.7 gram solution dissolved in ethyl acetate). The reactor was again sealed and purged of oxygen and held at 100 psig (793 kPa) nitrogen pressure. The reaction mixture was heated to 60° C. and the reaction proceeded adiabatically. During this reaction, a peak temperature of approximately 107° C. was observed.

### Example 9

### ODA/MMA/A-189 (60/35/5) Weight Percent

The procedure of Example 5 was repeated, except for the following particulars: In the first reaction, the adiabatic reaction apparatus was charged with 70 grams of a mixture of ODA, MMA, and A-189 in a weight percent ratio of 60/35/5 respectively, and further with 0.1 pph of Irganox 1010, and 0.04 pph of VAZO 52. During the first reaction, a peak temperature of approximately 109° C. was observed.

To 70.00 grams of the reaction product of the first step was added 0.05 pph of VAZO 52, 0.01 pph of VAZO 67, 0.01 pph of VAZO 88, 0.006 pph of LUPERSOL 101, and 0.008 of LUPERSOL 130. (These components were added as a 0.7 gram solution dissolved in ethyl acetate). The reactor was again sealed and purged of oxygen and held at 100 psig (793 kPa) nitrogen pressure. The reaction mixture was heated to 60° C. and the reaction proceeded adiabatically. During this reaction, a peak temperature of approximately 111° C. was observed.

### Example 10

### BHA/MMA/A-189 (40/55/5) Weight Percent

The procedure of Example 5 was repeated, except for the following particulars: In the first reaction, the adiabatic reaction apparatus was charged with 70 grams of a mixture of behenyl acrylate BHA, MMA, and A-189 in a weight percent ratio of 40/55/5 respectively, and further with 0.1 pph of Irganox 1010, and 0.04 pph of VAZO 52. During the first reaction, a peak temperature of approximately 109° C. was observed.

To 70.00 grams of the reaction product of the first step was added 0.05 pph of VAZO 52, 0.01 pph of VAZO 67, 0.01 pph of VAZO 88, 0.006 pph of LUPERSOL 101, and 0.008 of LUPERSOL 130. (These components were added as a 0.7 gram solution dissolved in ethyl acetate). The reactor was again sealed and purged of oxygen and held at 100 psig (793 kPa) nitrogen pressure. The reaction mixture was heated to 60° C. and the reaction proceeded adiabatically. During this reaction, a peak temperature of approximately 145° C. was observed.

### Examples of (Meth)Acrylic Oligamers with Radiation Initiated Preparation in a Bag

### Example 11

### ODA/MMA/A-189 (60/35/5) Weight Percent

A 70 gram quantity of a mixture of ODA, MMA, and A-189 in a weight percent ratio of 60/35/5 respectively, and further with 0.15 pph of IRGACURE 651 was filled into a 4.4 cm×9.5 cm bag. The filled bag was then heat sealed at the top and in the cross direction through the monomer-filled region to form individual bags of approximately 20 ml each of the mixture. The filled bags were placed in a water bath that was maintained at 30° C. and were exposed to UV radiation with an irradiance of 4.5 mW/cm² for 20 minutes. At the end of the exposure, the bags were removed from the water bath, dried and opened using a razor blade to release the oligomers formed by reaction of the mixture.

### Example 12

### ODA/MMA/A-189 (40/55/5) Weight Percent

The procedure of Example 5 was repeated, except for the following particulars: The bag was charged with 70 grams of a mixture of ODA, MMA, and A-189 in a weight percent ratio of 40/55/5 respectively, and further with 0.1 pph of Irganox 1010.

### Example 13

### ODA/IBOA/A-189 (60/35/5) Weight Percent

The procedure of Example 5 was repeated, except for the following particulars: The bag was charged with 70 grams of a mixture of ODA, IBOA, and A-189 in a weight percent ratio of 60/35/5 respectively, and further with 0.1 pph of Irganox 1010.

### Example 14

### ODA/IBOA/A-189 (40/55/5) Weight Percent

The procedure of Example 5 was repeated, except for the following particulars: The bag was charged with 70 grams of a mixture of ODA, IBOA, and A-189 in a weight percent ratio of 40/55/5 respectively, and further with 0.1 pph of Irganox 1010.

### Examples of (Meth)Acrylic Oligamers Used as Moisture Curable Release Materials

### Example A

### ODA/AN/A-189 (60/35/5) Weight Percent

In a narrow mouth amber quart jar were charged 36 g of octadecyl acrylate, 21 g of acrylonitrile, 3 g of 3-mercaptopropyl trimethoxy silane, 0.6 g of VAZO 67 initiator and 140 g of ethyl acetate. The resulting homogeneous mixture was purged with nitrogen at 1 LPM for 5 minutes. After purging with nitrogen, the bottle was sealed and tumbled in a constant temperature water bath at 65° C. for 36 hours. After that the bottle was cooled to room temperature followed by measuring % solids at 105° C. for 1 hr. The percent solids was determined to be 29.1% w/w.

### Example B

### ODA/AN/A-189 (63/35/2) Weight Percent

In a narrow mouth amber quart jar were charged 37.8 g of octadecyl acrylate, 21 g of acrylonitrile, 1.2 g of 3-mercaptopropyl trimethoxy silane, 0.6 g of VAZO 67 initiator and 140 g of ethyl acetate. The resulting homogeneous mixture was purged with nitrogen at 1 LPM for 5 minutes. After purging with nitrogen, the bottle was sealed and tumbled in a constant temperature water bath at 65° C. for 36 hours. After that the bottle was cooled to room temperature followed by measuring percent solids after heating a sample at 105° C. for 1 hr. The percent solids was determined to be 29.1% w/w.

The materials of Examples A and B were diluted to 5% solids with toluene and the diluted solutions were coated onto 2 mil (50 micrometer) thick Mitsubishi Hostaphan 3SAB primed PET film using a #6 Meyer rod. The coatings were dried at 149° F. (65° C.) for about 10 minutes and were expected to have thickness of about 150 nm.

The coatings were allowed to cure for 3 days at 73° F. (about 23° C.) and 50% relative humidity conditions, followed by lamination of 1″ (2.54 cm) wide strips of 845 and 850 tapes (available from 3M Co., St. Paul, Minn.) to the coatings using 2 passes of a 5 lb (11 kg) roller. The laminates were allowed to age for 3 days at 73° F. (about 23° C.) and 50% relative humidity and for 3 days at 149° F. (65° C.). The heat aged laminates were allowed to re-equilibrate for one day at 73° F. (about 23° C.) and 50% relative humidity prior to testing.

The overall peel force and readhesion values are shown in Table 2, along with a percent readhesion (based on Control readhesion values for a conventional LAB used on SCOTCH™ MAGIC™ Tape, product of 3M Company, St. Paul, Minn.).

TABLE 2

| | | 3 days CT/CH aging | | | | 3 days 65 C. aging | | |
|---|---|---|---|---|---|---|---|---|
| | | Test | peel force | readhesion | % Read- | peel force | readhesion | % Read- |
| Example | Description | Tape | (oz/in) | (oz/in) | hesion | (oz/in) | (oz/in) | hesion |
| A | ODA/AN/A-189 | 845 | 14.9 | 25.4 | 89.5 | 16.3 | 23.3 | 109 |
| | 60/35/5 | 850 | 9.5 | 32.6 | 118 | 17.2 | 32.2 | 87 |
| B | ODA/AN/A-189 | 845 | 12 | 31.4 | 111 | 18.3 | 23.8 | 111 |
| | 63/35/2 | 850 | 7.7 | 33.6 | 121 | 16.9 | 31.9 | 86 |
| Control | | 845 | 13.3 | 28.4 | | 13.2 | 21.4 | |
| | | 850 | 12 | 27.7 | | 13 | 37 | |

The above results show that these low molecular weight oligomers can be used as low adhesion backsizes for various types of pressure sensitive adhesives. These oligomers can be synthesized at 100% solids to yield formulations which may be extruded and cured on a major surface of a substrate such as a cast (co)polymeric film or paper, or these materials can be coated out of organic solvents or water on a major surface of a substrate such as a cast (co)polymeric film or paper.

Reference throughout this specification to “one embodiment,” “certain embodiments,” “one or more embodiments” or “an embodiment,” whether or not including the term “exemplary” preceding the term “embodiment” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A composition comprising at least one moisture-curable, semi-crystalline (meth)acrylic oligomer formed as a reaction product of an alkyl (meth)acrylate compound having a carbon number from 16 to 40, an alkyl (meth)acrylate compound having a carbon number from 1 to 40, and at least one alkoxysilane compound including a (meth)acryloyl-functionality or a mercapto-functionality, wherein the at least one alkoxy silane compound includes alkyl moieties containing from 1-3 carbon atoms.

2. The composition of claim 1, wherein the at least one moisture curable, semi-crystalline (meth)acrylic oligomer is represented by the formula: 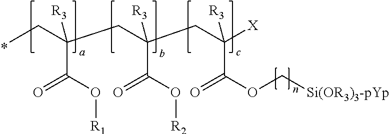
wherein:
R₁ is independently a C₁₆ to C₄₀ alkyl group;
R₂ is independently a C₁ to C₄₀ alkyl group;
each R₃ is independently a methyl, ethyl, or isopropyl group;
X is a chain transfer agent;
Y is independently selected to be a methyl, ethyl, or isopropyl group;
a, b and c are each independently selected to be an integer of at least 10, and a+b+c<1500;
n>1; and
p is 0, 1, 2, or 3.

3. The composition of claim 2, wherein R₁ comprises an alkyl (meth)acrylate having a carbon number from 16 to 30.

4. The composition of claim 3, wherein R₁ comprises an alkyl (meth)acrylate having a carbon number from 18 to 30.

5. The composition of claim 4, wherein R₂ comprises a least one monomer selected from the group consisting of an alkyl (meth)acrylate having a carbon number from 1 to 15, an alkyl (meth)acrylate having a carbon number from 16 to 40, a poly(ethylene) glycol-functional alkyl (meth)acrylate, a poly(propylene) glycol-functional alkyl (meth)acrylate, a urethane-functional alkyl (meth)acrylate, an epoxy-functional alkyl (meth)acrylate, or a combination thereof.

6. The composition of claim 5, wherein R₂ comprises an alkyl (meth)acrylate having a carbon number from 1 to 8.

7. The composition of claim 6, wherein the amount of R₂ in the moisture-curable, semi-crystalline (meth)acrylic oligomer is less than 30% w/w based on the total weight of the moisture-curable, semi-crystalline (meth)acrylic oligomer.

8. The composition of claim 2, wherein at least one R₃ is selected to be different from another R₃.

9. The composition of claim 2, wherein each R₃ is selected to be methyl.

10. The composition of claim 2, wherein n is no greater than 1500.

11. The composition of claim 1, wherein the at least one moisture curable, semi-crystalline (meth)acrylic oligomer has a weight average molecular weight less than or equal to 10,000 Da.

12. The composition of claim 1, wherein the composition is substantially free of an organic solvent.

13. An adhesive article comprising the composition of claim 1, optionally wherein the composition is at least partially cured to produce a low adhesion backsize opposite an adhesive layer on a substrate, or a primer layer for a low surface energy adhesive applied to the primer layer on a substrate.

14. The adhesive article of claim 13, wherein the substrate is selected from glass, ceramics, metals, metal oxides, cellulose, cellulose acetate, ethyl cellulose, poly(ethylene terephthalate), poly(ethylene naphthalate), polycarbonate, polypropylene, biaxially-oriented polypropylene, polyethylene, polybutylene, polyamides, or a combination thereof.

15. A process for making the composition of claim 1, comprising:
reacting a reaction mixture comprising:
the alkyl (meth)acrylate having a carbon number from 16 to 30,
the alkyl (meth)acrylate having a carbon number from 1 to 40, and
the alkoxysilane compound including a (meth)acryloyl-functionality or a mercapto-functionality, wherein the alkoxy silane compound comprises alkyl moieties containing from 1-3 carbon atoms.

16. The process of claim 15, wherein the alkoxy silane compound is selected from 3-mercaptopropyl trimethoxysilane, 3-methacryloxypropyltrimethoxysilane, and combinations thereof.

17. The process of claim 15, wherein reacting the reaction mixture comprises free radical polymerization, optionally under essentially adiabatic conditions, optionally in the absence of an organic solvent.

18. A process for making the adhesive article of claim 13, comprising applying the moisture-curable, semi-crystalline (meth)acrylic oligomer composition to a major surface of a substrate, and optionally curing the moisture-curable, semi-crystalline (meth)acrylic oligomer by reaction with a plurality of hydroxyl groups present on the major surface of the substrate.

19. The process of claim 18, wherein applying the moisture-curable, semi-crystalline (meth)acrylic oligomer composition to the major surface of the substrate comprises roll coating, Mayer rod coating, knife coating, curtain coating, slide coating, spray coating, electrospray coating, dip coating, gravure coating, bar coating, vapor coating, or a combination thereof.

20. The process of claim 18, further comprising heating the oligomer composition to accelerate reaction of the moisture-curable, semi-crystalline (meth)acrylic oligomer composition with the plurality of hydroxyl groups present on the major surface of the substrate.
